(19) United States
(12) Patent Application Publication
(10) Pub. No.: US 2015/0284591 A1
(43) Pub. Date: Oct. 8, 2015

(54) COATING FOR ROOFTOPS AND METHOD OF MANUFACTURE FOR SAME

(71) Applicants: Lindsay F. BROCK, Orangeville (CA); Ioana CRAICIU, Calgary (CA); Yik Tung Roy LEE, Calgary (CA); Farzana YUSUFALI, Ajax (CA)

(72) Inventors: Lindsay F. BROCK, Orangeville (CA); Ioana CRAICIU, Calgary (CA); Yik Tung Roy LEE, Calgary (CA); Farzana YUSUFALI, Ajax (CA)

(21) Appl. No.: 14/676,016

(22) Filed: Apr. 1, 2015

Related U.S. Application Data
(60) Provisional application No. 61/974,814, filed on Apr. 3, 2014.

(51) Int. Cl. C09D 183/04

(52) U.S. Cl. CPC C09D 183/04; C08K 3/36

(57) ABSTRACT

The disclosure is directed at a coating for rooftops or rooftop structures which is in a reflective state at a first temperature and in a non-reflective state at a second temperature. During colder months, the coating is in the non-reflective state while at warmer temperatures, the coating is in a reflective state.

### CROSS-REFERENCE TO OTHER APPLICATIONS

This application claims the benefit of U.S. Provisional Patent Application No. 61/974,814, filed Apr. 3, 2014, which is hereby incorporated by reference in its entirety.

### FIELD OF THE DISCLOSURE

The disclosure is directed generally at temperature-responsive materials, and more specifically, at a coating for rooftops and method of manufacture.

### BACKGROUND

Due to the rising cost of energy and the increasing scarcity of non-renewable resources, energy consumption has become one of the major issues facing the world today. In the United States, the yearly expenditure on electricity is the hundreds of millions of dollars, and the expenditure on natural gas for residential use alone is in the tens of billions of dollars. When associated tax incentives and penalties are factored in, reducing energy consumption has the potential to save both companies and home owners a great deal of money. As a result, there is a large movement throughout sectors to reduce energy consumption, and the demand for energy saving products is high. Products are being created across industries to meet this demand, ranging from light bulbs and appliances to cars and electronics. In the paint and coatings industry, various solutions have been developed to cater to this market. These products generally aim to reduce heating or cooling costs when applied to roofs or windows.

Therefore, there is provided a novel coating for rooftops capable of transitioning from a reflective state to non-reflective state based on temperature.

### SUMMARY

The disclosure is directed at a thermally-responsive coating capable of transitioning from a reflective state to a non-reflective state based on temperature. In a preferred embodiment, the coating is for use with dark coloured rooftops and similar structures. The afore-mentioned temperature may be the ambient temperature surrounding the rooftop or the temperature of the coating and/or rooftop itself. For instance, in a lower temperature environment such as during the winter, there is a desire for the rooftop to attract and/or absorb more sunlight and therefore, the coating is preferably clear or transparent at lower temperatures. In a higher temperature environment, such as the summer, there is a desire for the rooftop to reflect sunlight away from the rooftop, and therefore, the coating is preferably white at high temperatures. By having the coating change colour, advantages may be realized including, but not limited to, decreasing heating and cooling costs for the home or business owner.

This coating finds further benefit when applied to rooftops of building or housing structures in a continental climate. A continental climate may be defined as a climate which is characterized by cold winters and hot summers.

### BRIEF DESCRIPTION OF THE DRAWINGS

Embodiments of the present disclosure will now be described, by way of example only, with reference to the attached Figures.

FIG. 1a is a schematic diagram of a thermally-responsive coating applied to a house;

FIG. 1b is a schematic diagram of the thermally-responsive coating;

FIG. 2 is a flowchart outlining a method of manufacturing the thermally responsive coating of FIG. 1;

FIGS. 3a and 3b are schematic diagrams of the coating applied to a rooftop at a low temperature and a high temperature, respectively;

FIGS. 3c and 3d are photos of the coating applied to a surface at a temperature of 0 degrees Celsius and 60 degrees Celsius, respectively;

FIG. 4 is a graph illustrating refractive index versus temperature of the components of the coating; and

FIG. 5 is a graph showing measured solar reflectance of a coating.

### DETAILED DESCRIPTION

The disclosure is directed at a temperature-responsive coating for rooftops and a method for manufacturing the coating. In general, the coating transitions from a reflective state to a non-reflective state (and vice-versa) based on temperature. This temperature may either be the ambient temperature surrounding the rooftop or the temperature of the coating and/or rooftop.

Although different temperature ranges are considered, in one embodiment, the transition between the reflective state and the non-reflective state is preferably centerd on an ambient temperatures of about 20 degrees Celsius. As the temperature of some rooftops may exceed ambient temperature by about 30 degrees Celsius, the transition from the non-reflective state to the reflective state is preferably centered between from 40 to 60 degrees Celsius (if one is referring to the coating or rooftop temperature). This transition temperature may vary further as required by the particular application. Furthermore, in another embodiment, in the reflective state, it is preferred that the solar reflectance of the coating be between 0.35 and 1 and in the non-reflective state, it is preferred that the solar reflectance of the coating be between about 0 and 0.2.

In one embodiment, the coating is made from microparticles or nanoparticles of a first material, such as silica combined with a polymer matrix or a liquid polymer of a second material, such as Poly(dimethylsiloxane) (PDMS). Further examples of the first material include, but are not limited to titanium dioxide. Examples of the second material include, but are not limited to, other siloxane polymers such as poly(methylphenylsiloxane) or acrylate polymers such as poly(methyl acrylate). One of the preferred characteristics of the second material is that its refractive index experiences a relatively large change when exposed to a range of temperatures. In another embodiment, the coating may further include a curing agent for the second material.

In a preferred embodiment, the second material is selected such that the refractive index of the second material is close to or matches the refractive index of the first material at low temperatures thereby resulting in a transparent or clear coating. At high temperatures, the refractive index of the second material diverges from the refractive index of the first material which allows for Mie scattering (light being redirected by microscopic particles) to occur within the microparticles thereby resulting in the coating turning more white in colour (causing the rooftop to become more reflective). Some other parameters for material selection which may be considered include, but are not limited to, the particle size of the microparticles, the relative amounts of the first and second materials within the coating, the thickness of the coating to be applied to the rooftops and the necessity of additives to be added to the coating. In another embodiment, small amounts of a polymer with a different refractive index from a main polymer component of the second material may be used as an additive to tailor the refractive index of the second material. In the embodiment using silica as the first material and PDMS as the second material, one such additive may be poly(methylphenylsiloxane) (PMPS). Other such additives include, but are not limited to, any other siloxane polymer.

In use, the coating may be applied to rooftops (or other materials or structures which may benefit from changes in sunlight absorption in response to temperature changes). This application may be performed with the coating being painted or spray-coated onto the rooftops or applying the coating to shingles or other roofing materials which are to be laid on rooftops. The coating may also be applied as an uncured polymer-microparticle blend or as a latex paint.

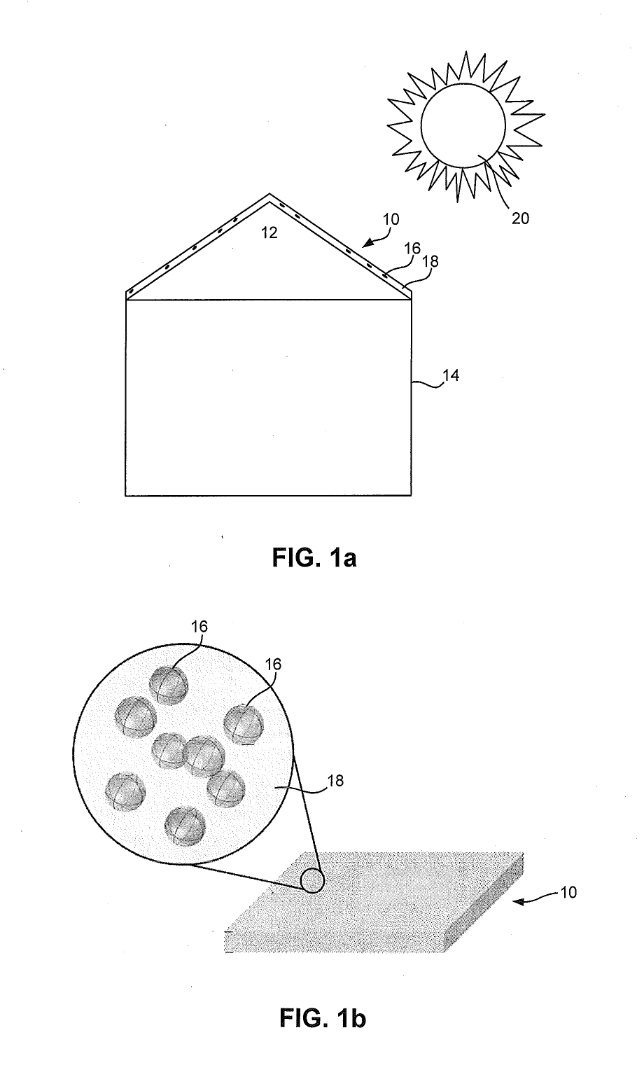

Turning to FIG. 1a, a schematic diagram of a coating for rooftops is shown. As shown, the coating 10 is applied to a rooftop 12 of a house 14. As will be understood, the coating may also be applied to a rooftop of a building structure, such as an office building or an apartment, and is not restricted to a rooftop of a house. The coating 10 includes a set of microparticles or nanoparticles 16 of a first material, such as silica, which is dispersed within a polymer of the second material 18, such as PDMS. When the microparticles 16 are dispersed or mixed with the polymer 18, the polymer is preferably in a state such that it can be applied as a coating to the rooftop. As understood, this coating will then dry, or harden, on the rooftop to provide a coating over the rooftop. In continental climates, exposure of the coating 10 to the sun 20 over the different seasons results in the temperature-responsive coating changing colour or transparency as will be described below.

In a preferred embodiment, the materials for the coating 10 are selected such that a reflective state of the coating occurs with the temperature of the coating (or the rooftop) at 50 degrees Celsius or above with a solar reflectance of about 0.35 to 1 while a non-reflective state of the coating occurs when the temperature of the coating (or rooftop) is below about 20 degrees Celsius with a solar reflectance of about 0 to 0.20.

In another embodiment, the coating is 50% wt of silica microparticles or nanoparticles which are dispersed in a liquid PDMS and then applied to a substrate and cured for a period of time, such as between 30 and 45 minutes, and most preferably around thirty-five (35) minutes, at a temperature of around 100 degrees Celsius to form a solid coating with a thickness ranging from 1.0 mm to 1.2 mm when applied to the rooftop. In yet another embodiment, the coating is 30% wt of silica microparticles and 70% wt of PDMS.

Turning to FIG. 1b, a schematic diagram of the coating is shown. The finished coating 10 includes the set of microparticles or nanoparticles 16 dispersed within the polymer 18.

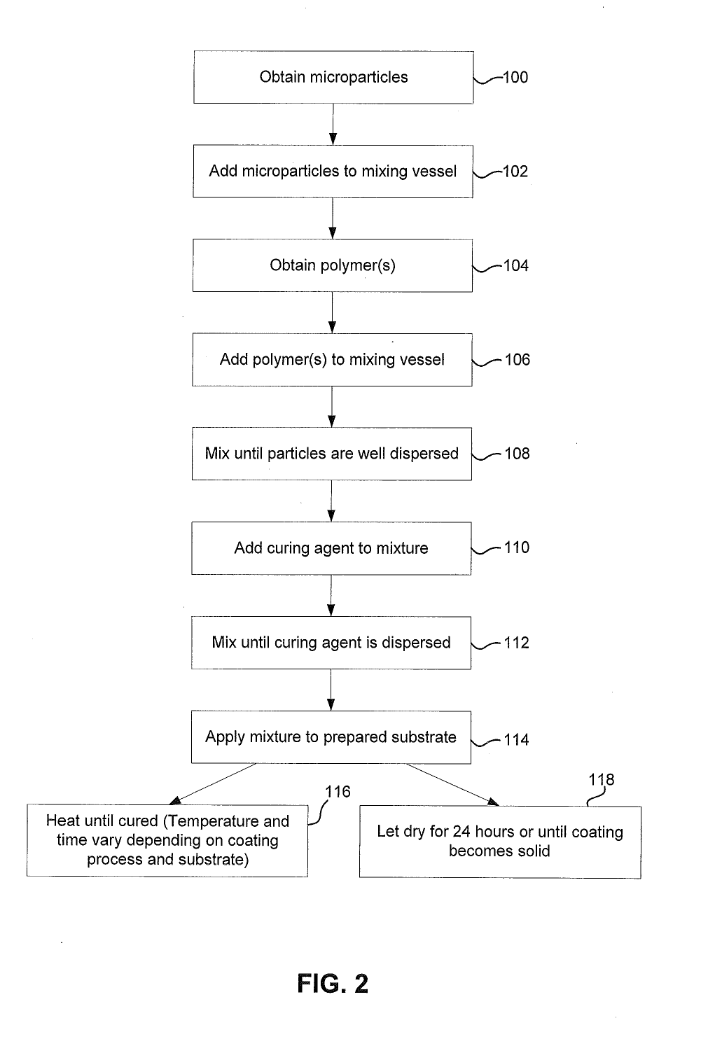

FIG. 2 is a flowchart outlining a method of producing a coating for use with rooftops

Initially, microparticles or nanoparticles of a first material are obtained 100. As outlined above, the first material may be silica. These microparticles are then added to a mixing vessel 102 before polymers, preferably liquid, of a second material are obtained 104 and then added 106 to the mixing vessel. The order of material addition could optionally be reversed. As outlined above, the second material may be PDMS.

The combination of the microparticles and the polymers are then mixed such that the microparticles are well dispersed within the polymer 108. A curing agent can then be added 110 to the mixture although, depending on the selection of the first and second materials, there may not been a need for a curing agent. In the current method, the curing agent is mixed until it is dispersed within the solution in the mixing vessel 112. The coating can then be applied to a substrate 114. After application to the substrate, the substrate (such as a rooftop or a shingle) and coating can be heated until it is cured 116. The temperature and time may vary depending on the coating process and the substrate. In one embodiment, the substrate may be left to air dry for a predetermined period or equipment such as a roof dryer may be used. Alternatively, the coating and substrate can be dried for a period of time, such as 24 hours, allowing the coating to become a solid on top of the substrate 118.

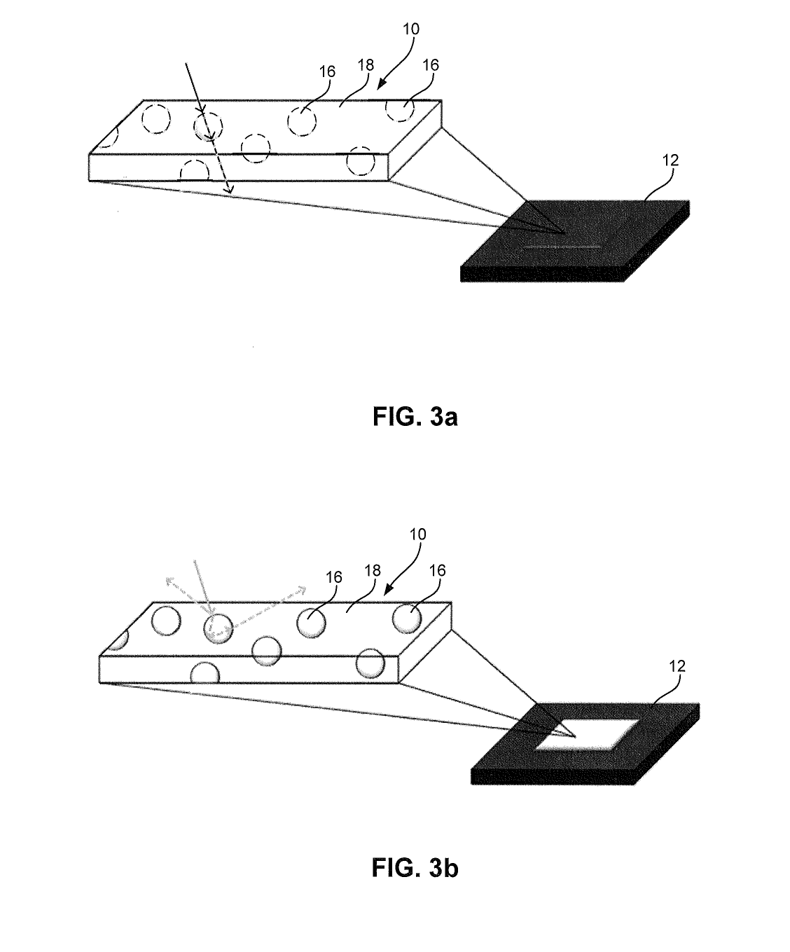

FIGS. 3a and 3b are schematic diagrams of the coating at low and high temperatures, respectively. In FIGS. 3a and 3b, the coating 10 includes the set of microparticles of the first material 16 which are dispersed within the polymer 18 of the second material. As will be understood, for purposes of application onto a rooftop or a rooftop structure, the coating is typically in a liquid form but for simplicity of display the coating has been shown in a block form to indicate a solid state (after curing or drying).has been shown as a block. The coating has been shown on a black roofing material (such as a shingle).

In FIG. 3a, when the ambient temperature surrounding the coating or rooftop is at a low temperature, for instance at 10 degrees Celsius, the refractive index of the first material, (n1) is the same as the refractive index (n2) of the second material thereby resulting in a transparent coating on the rooftop 12. As shown, since the refractive indices are close to identical, or may even be identical, the coating is transparent and therefore, light is able to pass through the coating and be absorbed by the roof. In FIG. 3b, when the ambient temperature surrounding the coating or rooftop is at a high temperature, for instance at 30 degrees Celsius, the refractive index of the first material (n1) does not equal the refractive index (n2) of the second material thereby resulting in a coating which turns white on the rooftop 12. Therefore, due to the difference in refractive indices, the change in reflectance of the coating causes light (in the form of rays of sunshine) to be reflected away from the rooftop. Photographs reflecting the colour of the coating at different temperatures is provided at FIGS. 3c and 3d.

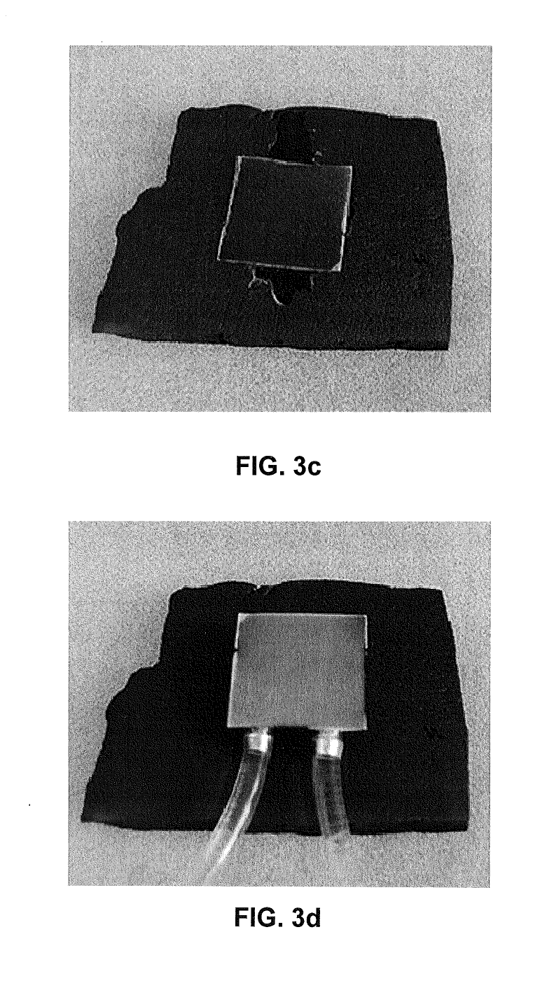

In the graph of FIG. 4, a graph illustrating a relationship between refractive index and temperature is shown. The Y-axis for this graph represents the refractive index while the X-axis represents the temperature in degrees Celsius. In FIG. 4, the solid line represents the refractive index of the first material, which in this graph is silica microparticles, and the dotted line represents the refractive index of the second material, which in this graph is a polymer blend.

As can be seen, as the temperature rises, the refractive index of the silica microparticles slightly increases over the temperature range of 0 to 60 degrees Celsius while the refractive index of the polymer blend lowers significantly over the same temperature range. It can be seen that at approximately 4 degrees Celsius, the refractive index of the silica microparticles and the polymer material are the same. Selection of the first and second materials may be based on the temperatures of the coating or rooftop at which a user or manufacturer wishes to have the coating change color.

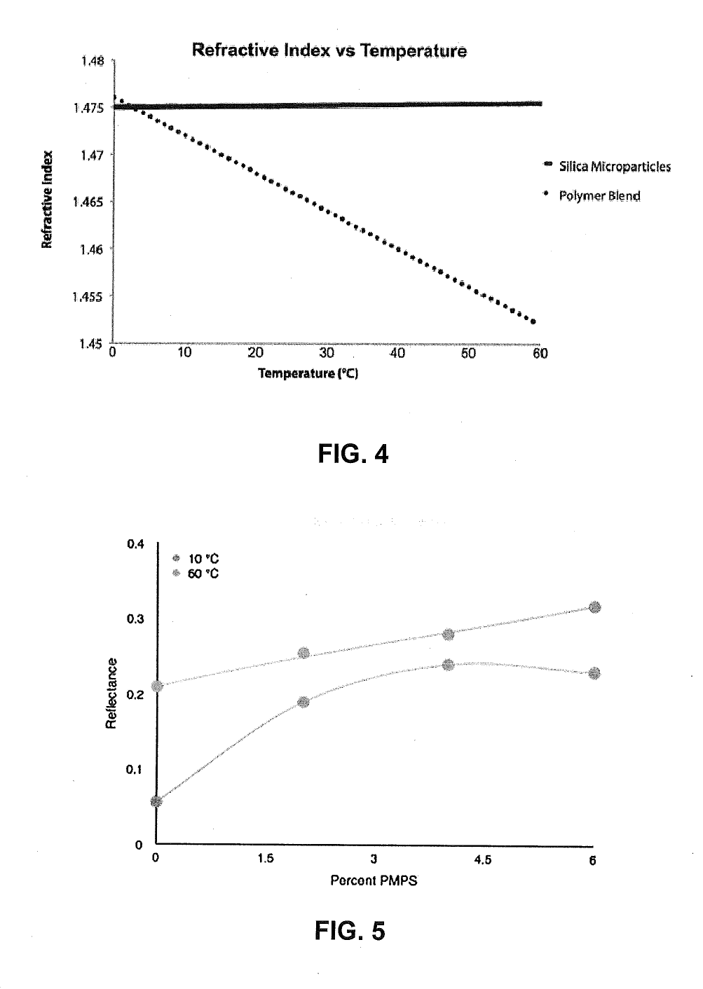

Turning to FIG. 5, a graph outlining solar reflectance is shown. The Y-axis represents solar reflectance while the X-axis represents a percentage of poly(methylphenysiloxane) (PMPS) in a mixture with PDMS. The top line represents readings taken at 10 degrees Celsius while the bottom line represents readings taken at 60 degrees Celsius. As can be seen, the PMPS additive changes the overall reflectance of the coating at any temperature, by effectively increasing the refractive index of the PDMS polymer.

Through the use of high particle loading, the selection of a polymer with a lower refractive index (around 1.47 at room temperature) and the addition of a second polymer to act as a refractive index modifier, the coating is developed to operate at a temperature lower than other solutions currently known. Currently known solutions are directed at different applications and change colours when the temperature of the coating is 80 degrees Celsius. In these applications., the material that is manufactured is directed for use in high-temperature optoelectronic devices, optical components with tunable translucency and simple heat detectors.

Other considerations for coating characteristics include, but are not limited to, ultraviolet (UV) stability, thermal cycling stability, water resistance, adhesion to a substrate such as shingles or other roofing materials and durability.

The above-described embodiments are intended to be examples only. Alterations, modifications and variations can be effected to the particular embodiments by those of skill in the art without departing from the scope of intended protection.

What is claimed is:

1. A coating for a building structure comprising:
microparticles of a first material; and
a polymer matrix of a second material; and
wherein the microparticles of the first material are dispersed within the polymer matrix of the second material;
wherein a refractive index of the first material and a refractive index of the second material are approximately equal at a first temperature; and
wherein the refractive index of the second material diverges from the refractive index of the first material as temperature rises to a second temperature.

2. The coating of claim 1 wherein the first material includes silica microparticles.

3. The coating of claim 2 wherein the first material is silicon dioxide (SiO₂).

4. The coating of claim 3 wherein the second material is polydimethylsiloxane (PDMS).

5. The coating of claim 4 wherein the first temperature is between approximately −20 and approximately 20 degrees Celsius.

6. The coating of claim 4 wherein the second temperature is between approximately 20 and approximately 70 degrees Celsius.

7. The coating of claim 3 further comprising a PDMS curing agent.

8. The coating of claim 7 wherein the silica microparticles are immersed into the PDMS at 30-50% by weight to form a solution.

9. The coating of claim 8 wherein the coating is approximately 90% by weight of the PDMS solution and 10% by weight of the PDMS curing agent.

10. A method of producing a coating comprising:
mixing microparticles of a first material with a liquid polymer of a second material to produce a solution; and
mixing the solution with a curing agent;
wherein a refractive index of the first material and a refractive index of the second material are approximately equal at a first temperature; and
wherein the refractive index of the first material diverges from the refractive index of the second material as temperature rises at a second temperature.

11. The method of claim 10 wherein mixing comprises:
placing the microparticles of the second material into a liquid bubble of the first material.

12. The method of claim 11 wherein the first material is silicon dioxide (SiO₂) and the second material is polydimethylsiloxane (PDMS).

13. The method of claim 11 wherein the curing agent is a PDMS curing agent.

14. The method of claim 10 furthering comprising, after mixing the solution with a curing agent, allowing the mixture to cure and form a solid coating.
